(19) United States
(12) Patent Application Publication
(10) Pub. No.: US 2017/0064301 A1
(43) Pub. Date: Mar. 2, 2017

(54) Methods and Apparatus for Use of Reference Block in Video Coding

(71) Applicant: Zhan Ma, Fremont, CA (US)

(72) Inventor: Zhan Ma, Fremont, CA (US)

(21) Appl. No.: 15/249,091

(22) Filed: Aug. 26, 2016

Related U.S. Application Data
(60) Provisional application No. 62/210,001, filed on Aug. 26, 2015.

(51) Int. Cl. H04N 19/109; H04N 19/174; H04N 19/70

(52) U.S. Cl. CPC H04N 19/109; H04N 19/70; H04N 19/174

(57) ABSTRACT

A method and apparatus for use of reference block based temporal prediction in video coding is disclosed. One or more syntax elements are provided for reference block based temporal prediction in encoding and decoding video signals. In one embodiment, a reference block enabling flag is introduced, which is suitable to indicate whether the reference block based or the legacy reference frame based temporal prediction is used. In one embodiment, a syntax element relating to the reference list is introduced, which is suitable to indicate whether the backward or forward reference buffer is used for prediction. In one embodiment, a syntax element relating to the reference differential distance is introduced, which is suitable to indicate the relative distance between a reference block and its predictor. In one embodiment, a syntax element relating to the reference distance predictor is introduced, which is suitable to indicate which reference block distance predictor is used for prediction.

### CROSS-REFERENCE TO RELATED APPLICATIONS

This application claims the benefit of the filing date of the following U.S. Provisional Application, which is hereby incorporated by reference in its entirety for all purposes: Ser. No. 62/210,001, filed on Aug. 26, 2015, and titled “Methods and Apparatus of Reference Block for Video Coding.”

### TECHNICAL FIELD

This invention relates generally to video encoding and decoding, and more specifically, to a method and an apparatus for video encoding and decoding using reference block for temporal prediction.

### BACKGROUND

The reference frame was introduced in video coding for temporal prediction to improve coding efficiency as compared to using reference in the same picture (or frame) for spatial prediction. The reference frame in temporal prediction are currently used in the following ways: 1) using multiple reference frames including the long-term and short-term pictures; 2) being used in Bi-prediction with both backward and forward reference lists; 3) being used in weighted prediction; 4) being used in flexible block structure to support arbitrary prediction.

Additionally, the reference block from the previously-reconstructed reference frame in the reference buffer has been used for prediction of the current block. Every block could be efficiently predicted if it has appeared previously. However, even for the same content that has appeared previously, its associated frame may be released from the reference buffer according to certain reference frame management protocol, due to the limited numbers of references that could be stored in the reference buffer due to the implementation cost, complexity and other reasons. The long-term reference has been introduced to partially resolve this issue. But the whole picture is required to be stored even if there is only one block referred in this reference picture. This makes the long-term reference a less efficient solution.

Separately, adaptive intra and inter mode has been utilized in almost every video coding technique to explore the respective spatial and temporal correlation and to increase coding efficiency. For those blocks that appear for the first time, intra coding will be chosen. But when the block could find its reference from previously reconstructed frames, inter mode will be used for better coding performance. As aforementioned, even if for the same content that has appeared previously, the reference frame containing the same content may have been released from the reference buffer and is not buffered any more. In that case, inter mode cannot be applied and intra mode is required. This happens often when 1) foreground objects move in and out, and 2) in background panning. Particularly, for screen content, it has frequent window switch, back-and-forth web scrolling and alike, which would bring back the same content that appeared few seconds ago (the corresponding frame likely is no longer buffered due to the limited reference buffer size).

Our invention further improves efficiency of video coding by introducing the reference block for temporal prediction. In a preferred embodiment, only reference blocks that will be used for the prediction of future frames are buffered.

### BRIEF SUMMARY

In one embodiment, a method for encoding a video signal is disclosed. Said method comprises providing an adaptive flag in a syntax, the adaptive flag being suitable to indicate whether reference frame based or reference block based temporal prediction is used for inter coding. Further, such adaptive flag can be included in a high level parameter set (such as the sequence parameter set (SPS) or the picture parameter set (PPS)), a slice segment header, or other enhancement messages (such as SEI). Reference block based temporal prediction is performed at the sequence level when such adaptive flag is set true at the SPS or PPS level. When such adaptive flag is set true in the slice segment header, reference block based temporal prediction is applied in the current slice.

In one embodiment, a method is disclosed for decoding a video signal, comprising parsing an adaptive flag in a syntax, said adaptive flag being suitable to indicate whether reference frame based or reference block based temporal prediction is used for inter coding. The adaptive flag provided in said method is further suitable to indicate whether reference frame based or reference block based temporal prediction is used for this sequence or this slice.

In one embodiment, a method is disclosed for encoding a video signal, comprising providing a syntax element suitable to indicate which of the forward reference buffer or the backward reference buffer is used for temporal prediction at the CTU level.

In one embodiment, a method is disclosed for decoding a video signal, comprising parsing a syntax element suitable to indicate which of the forward reference buffer or the backward reference buffer is used for temporal prediction at the CTU level.

In one embodiment, a method is disclosed for encoding a video signal, comprising providing a syntax element suitable to indicate the relative distance between the reference block location address and its predictor at the CTU level.

In one embodiment, a method is disclosed for decoding a video signal, comprising parsing a syntax element suitable to indicate the relative distance between the reference block location address and its predictor at the CTU level.

In one embodiment, a method is disclosed for encoding a video signal, comprising providing a syntax element suitable to indicate the reference block distance predictor at the CTU level.

In one embodiment, a method is disclosed for decoding a video signal, comprising parsing a syntax element suitable to indicate the reference block distance predictor at the CTU level.

In one embodiment, an encoder is disclosed wherein a method for encoding a video signal is applied, said method comprises providing an adaptive flag in a syntax, the adaptive flag being suitable to indicate whether reference frame based or reference block based temporal prediction is used. Such adaptive flag can be included in a high level parameter set (such as the sequence parameter set or the picture parameter set), a slice segment header, or other enhancement messages (such as SEI). Reference block based temporal prediction is performed at the sequence level when such adaptive flag is set true at the SPS or PPS level. When such adaptive flag is set true in the slice segment header, reference block based temporal prediction is applied in the current slice.

In one embodiment, a decoder is disclosed wherein a method for decoding a video signal is applied, said method comprising parsing an adaptive flag in a syntax, said adaptive flag being suitable to indicate whether reference frame based or reference block based temporal prediction is used. The adaptive flag provided in said method is further suitable to indicate whether reference frame based or reference block based temporal prediction is used for this sequence or this slice.

In one embodiment, an encoder is disclosed wherein a method for encoding a video signal is applied, said method comprising providing a syntax element suitable to indicate which of the forward reference buffer or the backward reference buffer is used for temporal prediction.

In one embodiment, a decoder is disclosed, wherein a method for decoding a video signal is applied, said comprising parsing a syntax element suitable to indicate which of the forward reference or the backward reference buffer is used for temporal prediction.

In one embodiment, an encoder is disclosed wherein a method for encoding a video signal is applied, said method comprising providing a syntax element suitable to indicate the relative distance between the reference block location address and its predictor.

In one embodiment, a decoder is disclosed, wherein a method for decoding a video signal is applied, said method comprising parsing a syntax element suitable to indicate the relative distance between the reference block location address and its predictor.

In one embodiment, an encoder is disclosed wherein a method for encoding a video signal is applied, said method comprising providing a syntax element suitable to indicate the reference block distance predictor.

In one embodiment, a decoder is disclosed, wherein a method for decoding a video signal is applied, said method comprising parsing a syntax element suitable to indicate the reference block distance predictor.

### BRIEF DESCRIPTION OF THE DRAWINGS

FIG. 1 is a diagram illustrating an encoding process, according to an exemplary embodiment of the present principles;

FIG. 2 is a flow diagram illustrating an exemplary method for performing the inter coding using the reference block based temporal prediction, according to an exemplary embodiment of the present principles;

FIG. 3 is a flow diagram illustrating an exemplary method for performing the inter decoding using the reference block based temporal prediction, according to an exemplary embodiment of the present principles;

FIG. 4 is a diagram illustrating one exemplary configuration of an encoder wherein an exemplary embodiment of the present principles can be applied;

FIG. 5 is a diagram illustrating one exemplary configuration of a decoder wherein an exemplary embodiment of the present principles can be applied; and

FIG. 6 is a diagram illustrating various components that may be utilized in an exemplary embodiment of the electronic devices wherein the exemplary embodiment of the present principles can be applied.

### DETAILED DESCRIPTION

The present principles are directed to reference block based temporal prediction in video encoding and decoding.

The following discusses various embodiments in the context of HEVC, and references the coding tree unit (CTU) used in HEVC when referring to a “coding block.” However, the present embodiments can be adapted to other video compression technologies, standards, recommendations and extensions thereof, and may also be applied to other types of video content in addition to screen content. The “coding block” is also not limited to CTU in HEVC, and can be of a different size or a different shape.

In one embodiment, a reference block based temporal prediction enabling flag is used to indicate whether the current slice or sequence uses the reference block based temporal prediction or the legacy reference frame based temporal prediction described in HEVC and its extensions. In another embodiment, a syntax element relating to the reference list is introduced to indicate whether the backward or forward reference buffer is used for the coding block for temporal prediction. In another embodiment, a syntax element relating to the differential distance is used to indicate the relative distance between the reference block address location and its predictor. In another embodiment, a syntax element relating to the distance predictor is used to describe the predictor used for reference block distance prediction.

Specifically, the reference block based temporal prediction enabling flag is configured to be adaptive at both the slice level and the sequence level. In one embodiment, a new syntax element is introduced in sequence parameter set (“SPS”) and/or picture parameter set (“PPS”): ref_block_enable_flag, and a new syntax element is introduced in the slice segment header: slice_ref_block_enable_flag, as shown in the tables below. Other syntax elements using different names but serving the same functions can be included in slice segment header, SPS, PPS, or other enhancement messages, such as SEI, in accordance with the present invention.

| seq_parameter_set_rbsp( ) | Descriptor |
|---|---|
| ... | |
| ref_block_enable_flag | u(1) |
| ... | |

| pic_parameter_set_rbsp( ) | Descriptor |
|---|---|
| ... | |
| ref_block_enable_flag | u(1) |
| ... | |

| slice_segment_header( ) | Descriptor |
|---|---|
| ... | |
| if (ref block enable flag) | |
| slice_ref_block_enable_flag | u(1) |
| ... | |

Descriptor u(1) for the two syntax elements—ref_block_enable_flag, and slice_ref_block_enable_flag—is defined as unsigned integer using one bit. The parsing process for this descriptor is specified by the return value of the function reading this one bit, interpreted as a binary representation of an unsigned integer with most significant bit written first. Descriptors u(1) used here is exemplary. Other bit encoding methods can also be applied.

Syntax element ref_block_enable_flag that equals to 1 specifies that the reference block based temporal prediction is enabled for the sequence level coding until it is set to 0 in sequent SPS or PPS. Syntax element ref_block_enable_flag that equals to 0 specifies that reference block based temporal prediction is disabled for the sequence level coding until it is set to 1 in the subsequent SPS or PPS. Syntax element slice_ref_block_enable_flag that equals to 1 specifies that reference block based temporal prediction is enabled for the current slice. Syntax element slice_ref_block_enable_flag that equals to 0 specifies that reference block based temporal prediction is disabled for the current slice. Syntax element slice_ref_block_enable_flag is inferred as 0 if the syntax element ref_block_enable_flag is set to 0.

In another embodiment, the syntax elements relating to the reference list, the differential distance and the distance predictor are introduced at the coding unit level. For example, as further described below, three syntax elements are introduced in the CTU header: ref_list_lX[x0][y0], ddistI[x0][y0], and distP[x0][y0]. Other syntax elements using different names but serving the same functions can be included in the coding unit, in accordance with the present invention.

| Prediction_unit( x0, y0, nPbW, nPbH ) { | Descriptor |
|---|---|
| ... | |
| if( slice_type = B) | |
| ref_list_lX [ x0 ][ y0 ] | ae(v) |
| ... | |
| ddistI[x0][y0] | ae(v) |
| distP[x0][y0] | ae(v) |
| ... | |

Descriptor ae(v) for the syntax elements ref_list_lX[x0][y0], ddistI[x0][y0] and distP[x0][y0] is defined as context-adaptive arithmetic entropy-coded syntax element with the left bit first. Note that Descriptors ae(v) used here is exemplary. Other bit encoding methods can also be applied.

Syntax element ref_list_lX that equals to 1 specifies that the backward reference list is selected, while ref_list_lX that equals to 0 specifies that the forward reference list is selected. If it is not presented in the bitstream, it is inferred as 0 and the forward reference list is used. Syntax element ddist specifies that the relative distance of the reference block from its predictor for current block. Syntax element distP specifies which predictor is used to predict the reference block distance.

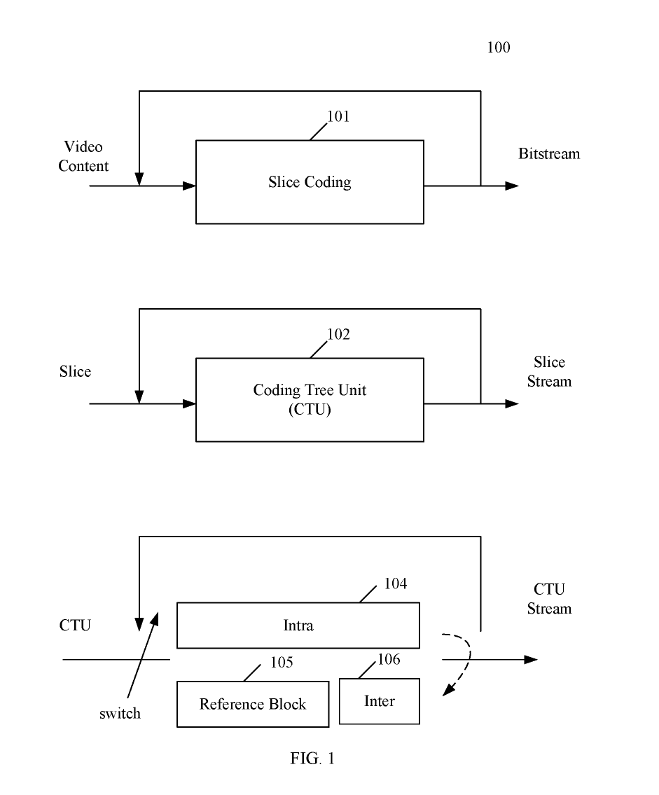

FIG. 1 illustrates an encoding process, according to an exemplary embodiment of the present principles. The encoder performs intra coding (104) using spatial prediction, and the encoder also performs the inter coding (106) using reference block based temporal prediction (105). Then the inter or intra mode is selected, for example, based on the RD cost or fast decision methods, to generate a CTU stream. At the slice level, all CTUs are encoded (102) to generate a slice stream. Then at a sequence level, the encoder encodes (101) all slices, for example, of a video content, to generate the output bitstream.

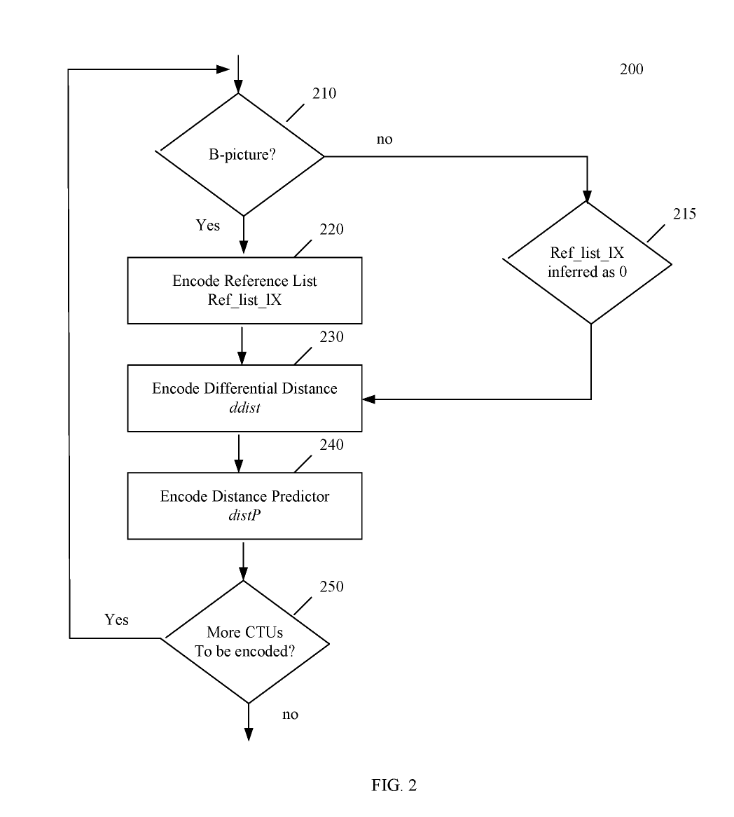

FIG. 2 illustrates an exemplary method 200 for performing the inter mode encoding using the reference block based prediction at the CTU level. Before an encoder proceeds to step 210, it checks whether the reference block enabling flag in the slice header (slice_ref_block_enable_flag) is set to 1. If yes, the encoder proceeds to step 210. If no, the encoder will use the legacy reference frame based temporal prediction. At step 210, the encoder checks whether the current block is in a B-picture. If the current block is in a B-picture, a syntax element indicating which reference list applies to the current block, such as ref_list_lX as defined above, is encoded into the stream at step 220. If the current block is not in a B-picture, the syntax element indicating which reference list applies to the current block, such as ref_list_lX is inferred as 0 at step 215, and is not encoded into the stream. At step 230, a syntax element indicating the relative distance for reference block such as ddist, is encoded into the stream. Another syntax element indicating the reference block distance predictor, such as distP, is encoded into the stream at step 240. At step 250, the encoder checks whether there are more CTUs to be encoded for the slice. If yes, the control is returned to step 210. Otherwise, the encoding of the slice is completed.

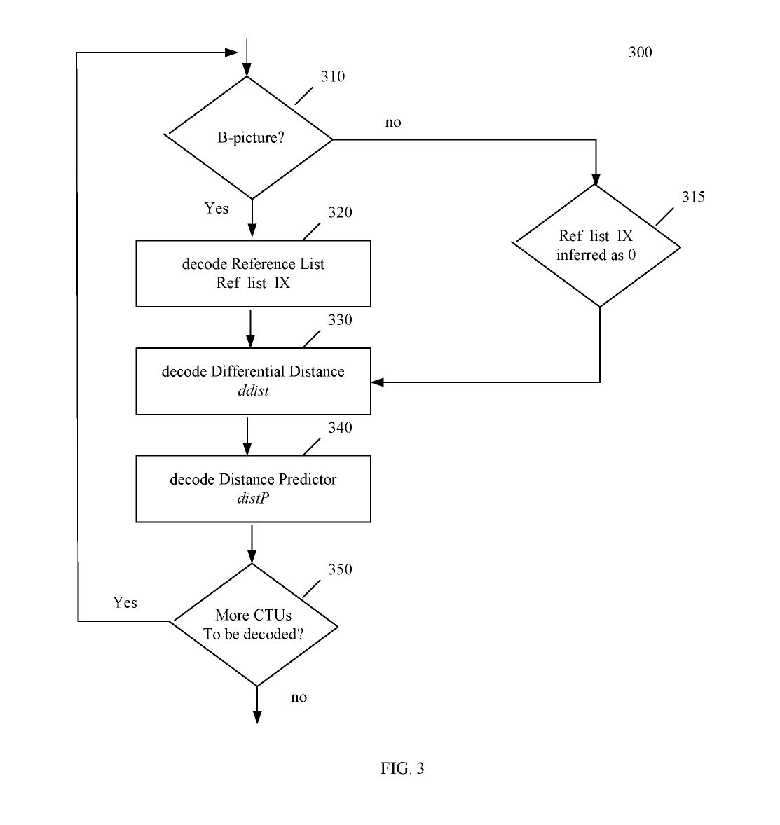

FIG. 3 illustrates a decoding method 300 for performing the inter mode decoding using the reference block based temporal prediction. Before a decoder proceeds to step 310, it checks whether the reference block enabling flag in the slice header (slice_ref_block_enable_flag) is set to 1. If yes, the decoder proceeds to step 210. If no, the decoder will use the legacy reference frame based temporal prediction. At step 310, the decoder checks whether current block is in a B-picture. If the current block is in a B-picture, a syntax element indicating which reference list applies to the current block, such as ref_list_lX as defined above, is parsed at step 320. If the current block is not in a B-picture, ref_list_lX is inferred as 0 at step 315. At step 330, a syntax element indicating the relative distance for reference block such as ddist, is decoded. Another syntax element indicating the reference block distance predictor, such as distP, is parsed at step 340. At step 350, the decoder checks whether there are more CTUs to be decoded for the slice. If yes, the control is returned to step 310. Otherwise, the decoding of the slice is completed.

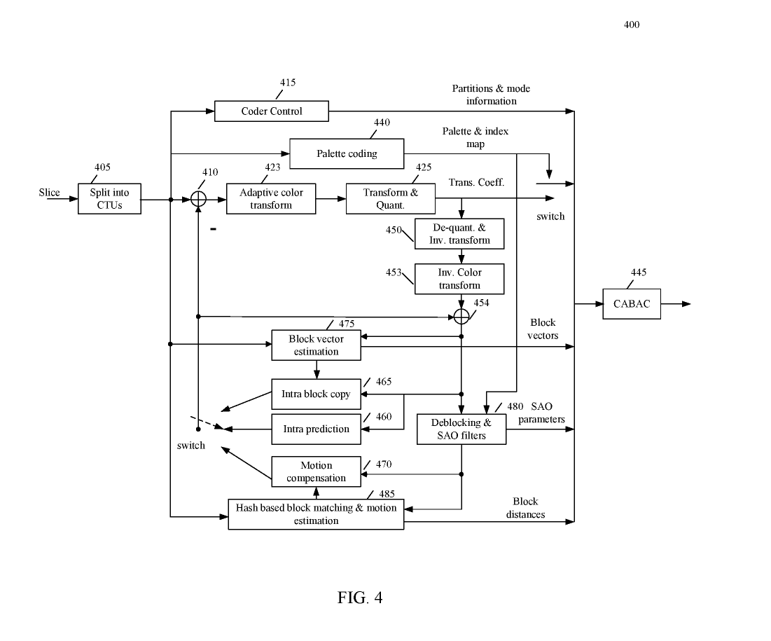

FIG. 4 illustrates an exemplary encoder 400 wherein the present embodiments can be applied. The input of apparatus 400 includes a video to be encoded. In the exemplary encoder 400, a picture to be encoded is split into CTUs 405 and is processed in units of CTUs. Each CTU is encoded using either an intra, or palette, or intra block copy or inter mode. When a CTU is encoded in an intra mode, it performs intra prediction 460. In an inter mode, the CTU performs motion estimation 485 and compensation 470 using the reference block based temporal prediction. In a palette mode, the CTU performs palette and corresponding index map coding 440. In an intra block copy mode, the CTU performs block matching 475 and copy 465. The encoder decides which one of them to use for encoding the coding unit 415, and prediction residuals are calculated by subtracting the predicted block from the original image block 410. The prediction residuals are then transformed and quantized at block 425. The quantized transform coefficients, as well as differential block distance, the distance predictor and other syntax elements, are entropy coded in block 445 to output a bitstream.

The encoder decodes an encoded block to provide a reference for further predictions. The quantized transform coefficients are de-quantized and inverse transformed to decode prediction residuals at block 450. Combining the decoded prediction residuals and the predicted block 455, an image block is reconstructed. A filter or an image processor is applied to the reconstructed block or the reconstructed picture at 465, for example, to perform deblocking and SAO filtering to reduce blockiness artifacts.

The encoder performs the coder control to adapt the bit rate, modes at block 415. Color transform at block 423 is applied to reduce the redundancy between different color components when using RGB or even YUV full color sampling video resource. Inverse color transform is performed at block 453 to reconstruct the color components through inter-component prediction. Palette mode at block 440 is used to transform conventional pixel domain block into color table and indices for encoding. Hash based motion search at block 485 is applied to fast locate corresponding predictive block at reference block buffer.

To integrate reference block based temporal prediction into encoder 400, the motion estimation module 470 would perform the reference block search and encode the block distances as described in method 200.

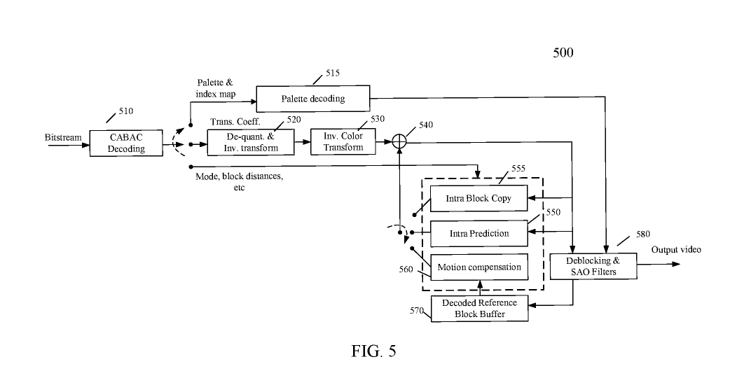

FIG. 5 depicts a block diagram of an exemplary video decoder 500 wherein the present embodiments can be applied. The input of apparatus 500 includes a video bitstream, which can be generated by video encoder 400.

In the exemplary decoder 500, the video bitstream is entropy decoded to have corresponding syntax elements at block 510. Inverse color transform 520, and dequantization and inverse transform 530 are performed to derive the prediction residuals. Residuals are added up at the predictive block 540. Each CTU is decoded using either an intra, or palette, or intra block copy or inter mode from the decode reference block buffer at block 570. When a CTU is decoded in an intra mode, it performs intra prediction in block 550 for the neighbor pixel prediction. In an inter mode, the CTU performs motion compensation and block compensation in block 560. Palette mode is directly reconstructed using parsed indices and color table to have the reconstructed samples at block 515. Reconstructed block from Palette mode is sent to the deblocking and SAO filtering at block 580 to reduce the artifacts. Filtered samples are buffered for prediction through decoded picture buffer 570 or directly using intra block 555, intra 550 or inter 560 modes, or are sent to output.

To integrate the reference block based temporal prediction into decoder 500, the motion compensation module 560 would perform inter mode decoding using reference block based temporal prediction, as described in method 300.

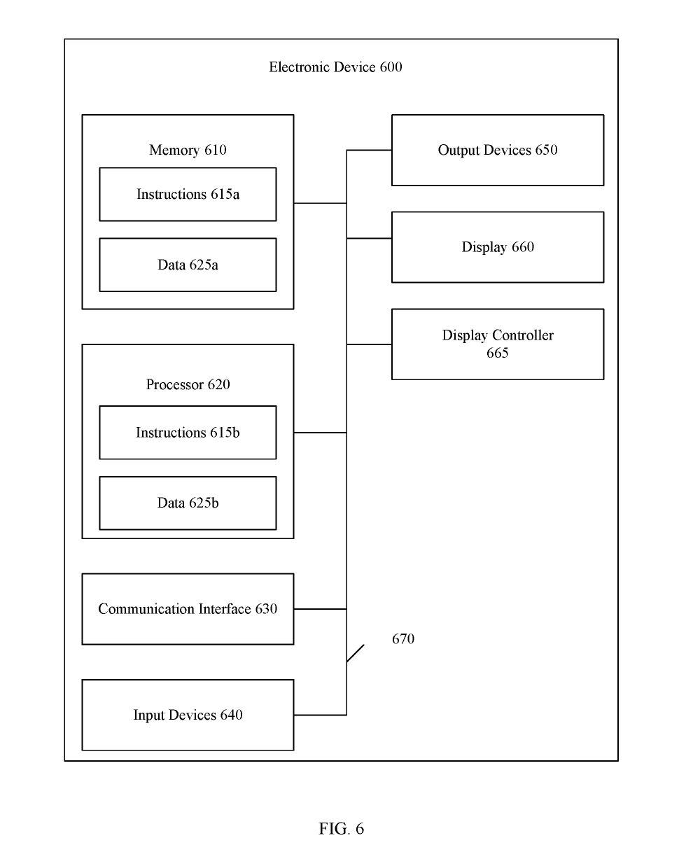

FIG. 6 illustrates various components that may be utilized in an electronic device 600. The electronic device 600 may be implemented as one or more of the electronic devices (e.g., electronic devices 400, 500) described previously.

The electronic device 600 includes a processor 620 that controls operation of the electronic device 600. The processor 620 may also be referred to as a CPU. Memory 610, which may include both read-only memory (ROM), random access memory (RAM) or any type of device that may store information, provides instructions 615a (e.g., executable instructions) and data 625a to the processor 620. A portion of the memory 610 may also include non-volatile random access memory (NVRAM). The memory 610 may be in electronic communication with the processor 620.

Instructions 615b and data 625b may also reside in the processor 620. Instructions 615b and data 625b loaded into the processor 620 may also include instructions 615a and/or data 625a from memory 610 that were loaded for execution or processing by the processor 620. The instructions 615b may be executed by the processor 620 to implement the systems and methods disclosed herein.

The electronic device 600 may include one or more communication interfaces 630 for communicating with other electronic devices. The communication interfaces 630 may be based on wired communication technology, wireless communication technology, or both. Examples of communication interfaces 630 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3^{rd} Generation Partnership Project (3GPP) specifications and so forth.

The electronic device 600 may include one or more output devices 650 and one or more input devices 640. Examples of output devices 650 include a speaker, printer, etc. One type of output device that may be included in an electronic device 600 is a display device 660. Display devices 660 used with configurations disclosed herein may utilize any suitable image projection technology, such as a cathode ray tube (CRT), liquid crystal display (LCD), light-emitting diode (LED), gas plasma, electroluminescence or the like. A display controller 665 may be provided for converting data stored in the memory 610 into text, graphics, and/or moving images (as appropriate) shown on the display 660. Examples of input devices 640 include a keyboard, mouse, microphone, remote control device, button, joystick, trackball, touchpad, touchscreen, lightpen, etc.

The various components of the electronic device 600 are coupled together by a bus system 670, which may include a power bus, a control signal bus and a status signal bus, in addition to a data bus. However, for the sake of clarity, the various buses are illustrated in FIG. 6 as the bus system 670. The electronic device 600 illustrated in FIG. 6 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods or approaches described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

1. A method for encoding a video signal, comprising providing a new syntax element suitable to indicate whether a reference block based temporal prediction or a reference frame based temporal prediction is used.

2. The method of claim 1, wherein said syntax element is suitable to indicate whether the reference block based or the reference frame based temporal prediction is used at a sequence level.

3. The method of claim 1, wherein said syntax element is suitable to indicate whether the reference block or the reference frame based temporal prediction is used at a slice level.

4. The method of claim 1, wherein said reference frame based temporal prediction is the legacy reference frame based temporal prediction defined in the HEVC and its extensions.

5. A method for decoding a video signal, comprising parsing a syntax element suitable to indicate whether a reference block based or a reference frame based temporal prediction is used.

6. The method of claim 5, wherein said the syntax element is suitable to indicate whether the reference block based or the reference frame based temporal prediction is used at a sequence level.

7. The method of claim 5 wherein said syntax element is suitable to indicate whether the reference block based or a reference frame based temporal prediction is used at a slice level.

8. The method of claim 5, wherein said reference frame based temporal prediction is the legacy reference frame based temporal prediction defined in the HEVC and its extensions.

9. A method of claim 1 further comprises providing a syntax element suitable to indicate whether the backward or the forward reference buffer is used.

10. The method of claim 9, wherein said syntax element is suitable to indicate whether backward or forward reference buffer is used at a block level.

11. A method of claim 9 further comprises providing a syntax element suitable to indicate the relative distance between a reference block and its predictor.

12. The method of claim 11, wherein said syntax element is suitable to indicate the relative distance between the reference block and its predictor at a block level.

13. A method of claim 9 further comprises providing a distance predictor in a syntax, the distance predictor being suitable to indicate the reference block predictor.

14. The method of claim 13, wherein said the distance predictor is suitable to indicate the reference block predictor is used at a block level.

15. A method for decoding a video signal, comprising parsing a syntax element suitable to indicate whether the backward or the forward reference buffer is used.

16. The method of claim 15, wherein said syntax element is suitable to indicate whether the backward or the forward reference buffer is used at a block level.

17. A method of claim 15 further comprises parsing a syntax element suitable to indicate the relative distance between a reference block and its predictor.

18. The method of claim 17, wherein said syntax element is suitable to indicate the relative distance between the reference block and its predictor at block level.

19. A method of claim 15 further comprises parsing a syntax element suitable to indicate a reference block predictor.

20. The method of claim 19, wherein said syntax is suitable to indicate the reference block predictor is used at block level.
